(19) United States
(12) Patent Application Publication
(10) Pub. No.: US 2018/0308028 A1
(43) Pub. Date: Oct. 25, 2018

(54) CONTROL OF PLANT-GROWING FACILITIES AND WORKFORCES

(71) Applicant: Aessense Technology Hong Kong Limited, Harbour City (CN)

(72) Inventors: Hong Zhang, Palo Alto, CA (US); Karl A. Kulik, American Canyon, CA (US); Yun Gao, Shanghai (CN); Haibin Zhang, Shanghai (CN); Xiongfeng Xu, Taicang (CN)

(21) Appl. No.: 15/962,843

(22) Filed: Apr. 25, 2018

Related U.S. Application Data
(60) Provisional application No. 62/489,961, filed on Apr. 25, 2017.
(60) Provisional application No. 62/598,896, filed on Dec. 14, 2017.

(51) Int. Cl. G06Q 10/06; G05B 19/418

(52) U.S. Cl. CPC G06Q 10/06311; G05B 2219/34338; G05B 19/41835

(57) ABSTRACT

A control system for plant-growing facilities can use growth plan templates representing programming for plant-growing devices performing automated operations and representing tasks for entry in a calendar and completion by a workforce of the plant-growing facilities. The growth plan templates may be authored or traded and may be modified based on data collect during instances in which the growth plan is used to grow batches of plants.

### CROSS-REFERENCE TO RELATED APPLICATIONS

This patent document claims benefit of the earlier filing date of U.S. provisional Pat. App. No. 62/489,961, entitled “Control of Plant Growing Facilities,” filed Apr. 25, 2017, and U.S. provisional Pat. App. No. 62/598,896, entitled “Plant Growth Facility Calendar-Based Task Management,” filed Dec. 14, 2017, both of which are hereby incorporated by reference in their entirety.

### BACKGROUND

Some modern hydroponic systems permit computerized control of automated operations performed by plant-growing devices. In particular, hydroponic facilities may employ many independently controllable hydroponic devices in which plants grow. The hydroponic devices may be of the same or different types, and each hydroponic device in the facilities may be remotely control or operated to perform desired automated operations. Such automated operations may include monitoring and controlling the characteristics of light provided to plants in the hydroponic devices, mixing and dispensing water and nutrients necessary for the plant growth, controlling the temperature around the plants, and providing ventilation or desired atmospheric conditions for growth of plants in the hydroponic devices. Such automated hydroponic devices typically require at least some direct human interaction, for example, for cleaning, testing, maintenance, or repair of the devices and for some operations, e.g., planting, transplanting, or harvesting, that may not fully implemented through automated systems.

Plant-growing facilities may have programming for the execution of the automated operations of plant-growing devices. Selecting, refining, and executing such programming in extended plant-growing facilities can be a complex task.

### SUMMARY

In accordance with an aspect of the invention, a control system for plant-growing facilities can provide user or automated control of one or more of growth plans. A growth plan template, for example, may define the type, sequence, and duration of automated operations performed by devices in the facilities and manual operations performed by a workforce of the facilities. The control system may be used to develop such growth plan templates, to communicate with devices performing automated operations, to communicate schedules or calendars to a workforce performing manual operations, and to record measurements and workforce log entries and record results for both automated and manual operations. The control system may further analyze the collected data and refine growth plans as needed to more efficiently employ and synchronizes both equipment and human resources.

In accordance with another aspect disclosed herein, a control system may be used to create and manage a repeatable task plans for workforce deployment, and the task plans may be integrated or synchronized with growth plans for execution of automated operations of plant-growing devices. The control system may particularly employ an integrated calendar that includes functionality for assignment of tasks to workers and for worker to report of task status or results.

One specific implementation is a control system for plant-growing facilities. The control system includes an execution module and one or more templates in a computing system. Each template represents programming for devices in the plant-growing facilities and one or more tasks to be performed during a growth plan. The computing system executing the execution module controls the devices while the devices are used to grow a batch of plants. In particular, the execution module is configured to program the devices based on the programming represented in the template. The execution module is further configured to generate one or more calendar entries based on the one or more tasks represented in the template, and each of the calendar entries identifies a time for a workforce to perform one of the tasks represented in the template.

Another specific implementation is a method that includes introducing a batch of plants into a plurality of plant-growing devices, selecting a growth plan template, and operating a control system executed in a computing system. Execution of the control system may perform operations including: programming the devices based on a programming represented in the grow plan template; and generating one or more calendar entries based on one or more manual tasks represented in the grow plan template. Each of the calendar entries identifies a time for a workforce to perform one of the manual tasks represented in the template.

### BRIEF DESCRIPTION OF THE DRAWINGS

FIG. 1 illustrates an example of a plant-growing device.

FIG. 2 is a block diagram illustrating interactions of a control system with plant-growing devices in plant-growing facilities.

FIG. 3 shows an example of a user interface displaying a site map and plant-growing devices assigned to “rooms” in a hierarchical organization of plant-growing facilities.

FIG. 4 shows an example of a user interface presenting a “Room View” showing data for devices assigned to a room in a hierarchical organization of plant-growing facilities.

FIG. 5 shows an example of a user interface displaying a site map and data associated with “rooms” in a hierarchical organization of plant-growing facilities.

FIG. 6 shows an example of a user interface providing a list of growth plan templates and enabling user access to create and alter growth plan templates.

FIG. 7 shows elements or fields in an exemplary data structure for a growth plan template.

FIG. 8 shows an example of a user interface when a control system provides a calendar containing tasks that may be created when a growth plan template is applied to create a growth plan instance.

FIG. 9 is a flow diagram of a process for using and improving a growth plan template.

The drawings illustrate examples for the purpose of explanation and are not of the invention itself. Use of the same reference symbols in different figures indicates similar or identical items.

### DETAILED DESCRIPTION

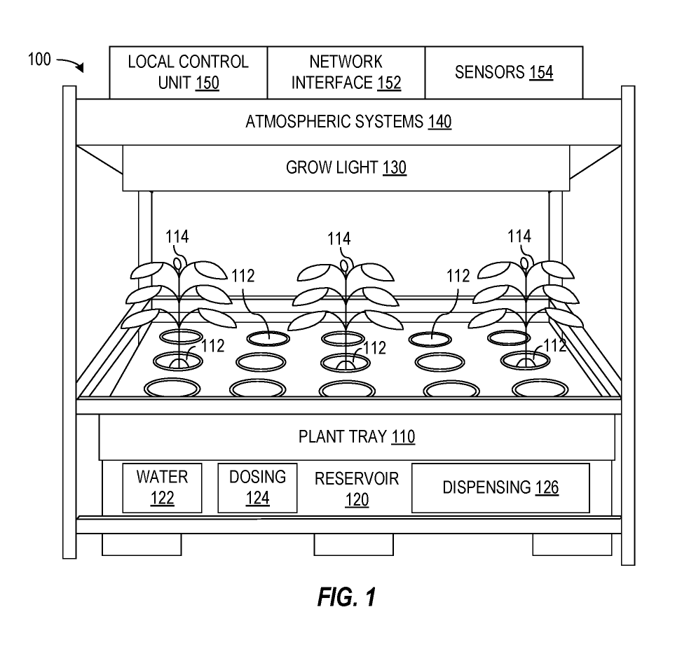

Plant-growing facilities may include one or more site and each site may include one or more physical rooms containing one or more devices for growing plants. FIG. 1 shows an example of a multi-function plant-growing device 100. Plant-growing device 100 includes a tray 110 contain an array of net pots 112, and each net pot 112 is sized and shaped to hold the roots of a plant, e.g., plants 114 in FIG. 1. The number, size, and shape of each net pot 112 in tray 110 may be chosen for the plant type, e.g., the species or strain, and the growth stage, e.g., germinating, seedling, vegetative, bud, flowering, or ripening stage, of plants 114. The roots of plants 114 typically extend through net pots 112 into a reservoir 120, and roots in reservoir 120 may be immersed in nutrient solution for traditional hydroponics or may be suspended air and periodically misted with nutrient solution for a type of hydroponics sometimes referred to as aeroponics. (The term hydroponic as used herein is not limited to systems that immerse the roots of plants in a nutrient solution but includes aeroponic and other technologies for growing plants without soil.) Reservoir 120 accordingly may accommodate or be connected to automated systems such as a system 122 for supplying water, a system 124 for mixing or dosing water with nutrients to create a nutrient solution, and a system 126 for dispensing of nutrient solution to plants 114. Plant-growing device 100 further includes other automated systems such as a grow light system 130 and atmospheric systems 140. Grow light 130 illuminates plants 114 in tray 110 with photosynthetically active light. Atmospheric systems 140 may include systems for controlling the flow, temperature, or chemical composition, e.g., the humidity or CO₂ concentration, of the air around plants 114.

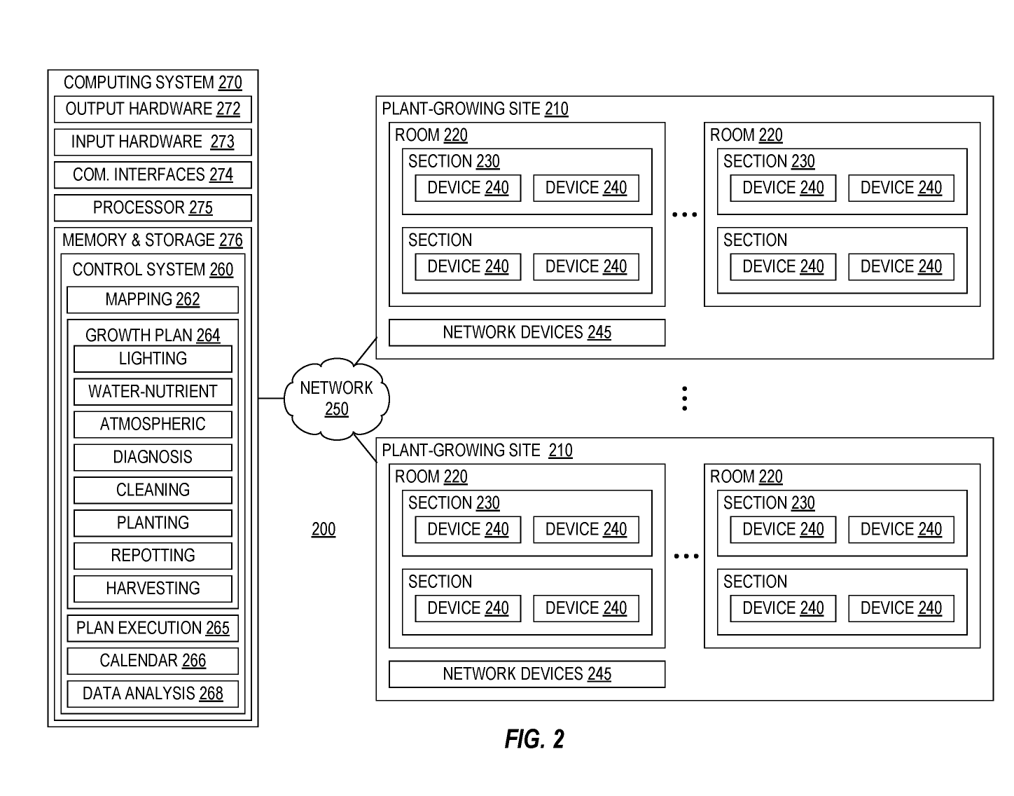

A local control unit 150, which may be a programmable controller or electronic computing system, may control operation of any or all of systems 122, 124, 126, 130, and 140. Local control unit 150 may be associated solely with plant-growing device 100 or may be shared by a group of plant-growing devices, e.g., a row of interconnected plant-growing devices or all devices in a room at a site. Local control unit 150 may communicate with a facilities control system as describe further below with reference to FIG. 2. In particular, local control unit 150 may employ network interface hardware 152 and a network such as a local area network (LAN), a wide area network (WAN), or a public network, e.g., the Internet, for communications with the facilities control system or other devices. The facilities control system may use the network communications to program local control unit 150, which may in turn control of automated operations such as performed by systems 122, 124, 126, 130, and 140 in plant-growing device 100.

Local control unit 150 may further collect measurement data from sensors 154, which may be located in the operational systems 122, 124, 126, 130, and 140 or elsewhere in or around associated plant-growing device(s) 100, and local control unit 150 may communicate data to the facilities control system. In particular, sensors 154 may sense operating parameters of plant-growing system 100 or local environmental conditions such as the temperature and composition or air around plants 114, the level, temperature, conductivity, or composition of nutrient solution in reservoir 120, the levels of supply canisters (not shown) for gases and liquid plant nutrients, and the operating conditions of pumps, fans, and other subsystems of hydroponic system 100. Based on such measurements from sensors 154 and on user commands or the programming of local control unit 150, local control unit 150 may control automated operations such as controlling the duration, intensity or spectrum of light from grow light 130 when grow light 130 supplies light to plants 114. Local control unit 150 may further coordinate automated operations of subsystems such as nutrient dispenser canisters, water supply valves, and pumps for automated mixing and application of nutrient solutions for plants 114 and subsystems such as gas supplies, exhaust fans, heating or cooling systems for automated operations to control atmospheric conditions around plants 114.

FIG. 1 is just one example of a plant-growing device 100 that can perform multiple automatic operations that provide for the needs of growing plants 114. Alternatively, devices used for growing plants may have many other configurations. For example, a plant-growing device may include multiple modules that operated together, and each module may separately include some of the systems or features of plant-growing device 100 and may share other systems. For example, devices in a row may respectively include separate grow light systems 130 but may share water supply system 122, dosing system 124, and local control unit 150 with other devices in the row. Further, some features of a plant-growing device 100 may alternatively be provided in or by the surrounding environment, i.e., by a natural setting or building, containing the plant-growing device. Also, a plant-growing device may include fewer (or more) automated systems than those of plant-growing device 100 of FIG. 1 and may accordingly rely on manual operations or a workforce performing more (or fewer) of the operations or procedures needed to successfully grow plants.

FIG. 2 illustrates how plant-growing devices such as multi-function plant-growing device 100 of FIG. 1 and single-function devices may be deployed in an extended plant-growing facilities 200. Plant-growing facilities 200 may include one or more sites 210. Each site 210 may include all or part of a building or other structure containing one or more subdivisions such as rooms 220. The subdivisions or rooms 220 of a site 210 may contain plant-growing devices 100 or may be used for other purposes. In particular, one of the plant-growing sites 210 may contain electronic equipment such as networking equipment 245 or a computing system 270 in which a facilities control system 260 as disclosed herein may be implement. Other rooms may be for storage of supplies or harvests from the plants being grown or may function as offices or to service the needs of personnel or visitors.

Each room 220 contains one or more devices 240 associated with growing plants in that room 220. Devices 240 in a room 220 may be of the same type or different types. A device 240 may be a multi-function plant-growing device such as plant-growing device 100 of FIG. 1, or a device 240 may be a separate or room-level system such as a sensor, lighting system, heating ventilation and air conditioning (HVAC) system that assists in or provides for the growing of plants but does not contain the plants. Devices 240 in a room 220 may be used to grow the same types and age of plants or to grow plants of different types, ages, or sizes. Specific sets of devices 240 may be physically or logically grouped together to form a section 230, e.g., all devices in a row or all devices assigned to growing the same type and age of plant.

Some or all of devices 100 may be able to communicate (directly or indirectly) through a network 250 with a facilities control system 260. In the example implementation of FIG. 2, facilities control system 260 is implemented in computing system 270. Computing system 27 may, for example, be a server, a desktop computer, a laptop computer, a tablet, or a smart phone with suitable hardware, firmware, and/or software for implementing the functions disclosed herein. Computing system 270 may particularly include: output hardware 272 such as a display, a speaker, or other devices for conveying information to a user; input hardware 273 such as a keyboard, a mouse or other pointing device, a touch screen, a microphone, a camera, or any interface suitable for the input of commands or other information from a user; communication interfaces 274 such as network interfaces for communication with other electronic devices via network 250; a processor 275; and memory and storage 276 for data and instructions executable by processor 275.

In the illustrated implementation, facilities control system 260 is configured to communicate with one or more plant-growing sites 210, rooms 220, sections 230, or devices 240 through network 250. Network 250 may include a public network such as the Internet, a wide area private network, or a local area network and may implement communications through physical wire or fiber links or through wireless links.

Facilities control system 260 further encompasses a mapping module 262 for hierarchical mapping of devices throughout the plant-growing facilities, a growth plan module 264 for developing of growth plan templates, a growth plant execution module 265 for applying a growth plan, e.g., programming devices 240 and calendaring tasks for a workforce, a calendar module 266 for planning automated and manual operations and providing communications to and from a workforce, and a data analysis module 268 configured modify or improve growth plan templates based on analysis of data collected during execution of growth plans.

Mapping module 262 may allow a user, particularly an administrator of the facilities, to manage devices 240 using a hierarchy of sites, rooms, sections, and devices to categorizes or distinguish the devices 240 performing automated operations. As shown in FIG. 2, plant growth facilities 200 may include multiple sites 210, which may be located in multiple locations and may be in different cities, states, or even countries. Every site 210 can have many rooms 220. The site, room, section, device concept can be adopted recursively in levels to create a hierarchical identification or designation of devices 240.

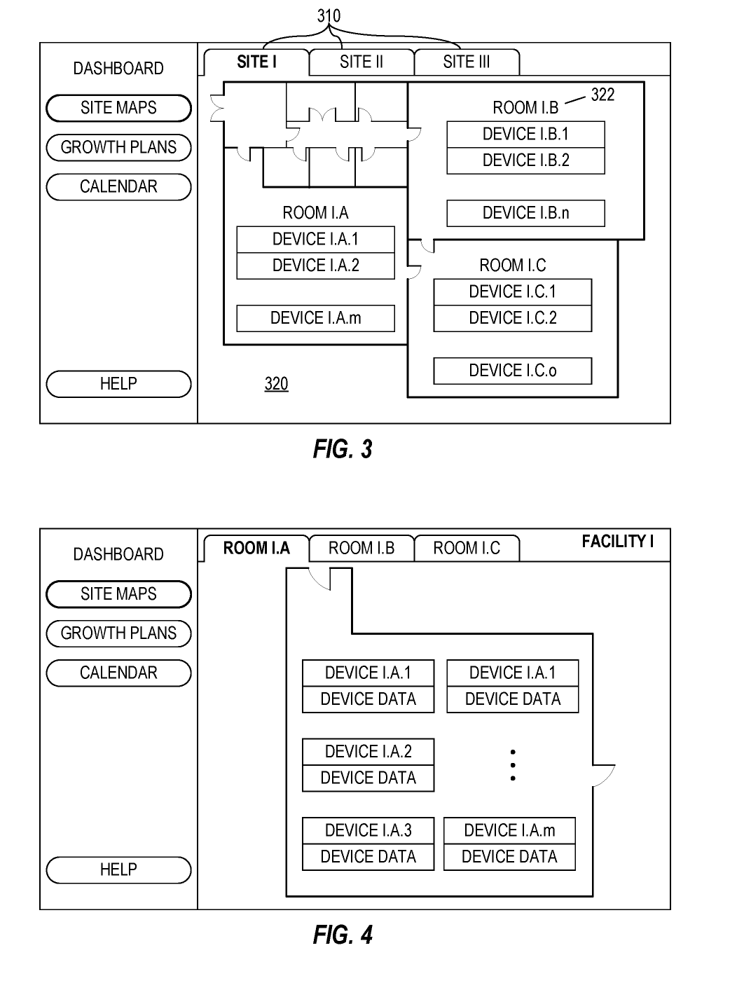

FIG. 3 shows an example display portion of a user interface that facilities control system 260 uses to represent plant-growing facilities when a user selects site mapping. In this example, the plant-growing facilities display represents the sites (Site I, Site II, and Site III) as selectable tabs 310, and provides a site map 320 graphically representing the layout of the selected site. Site map 320 may use conventional floor plant symbols to represent walls, rooms, and other features a site. A user may initially create the site map using convention CAD or drawing tools, which may apply building parameters or characteristics such as sizes and locations of rooms, doors, and other features of the site. The representations of rooms and other features of the site may be configurable (resizable) and locations of rooms and other features may be changed (draggable) and shape can be changed. A user may particularly organize a site map according to the actual floor of the site in a manner similar to internal house design. Rooms may be logically added at a level below sites in the hierarchy as entities for containing a set of sections or devices, which may be one or more level below rooms in the hierarchy. In general, a dimensionally accurate representation of a site may not be necessary for control of devices, but an accurate representation may assist in planning the arrangement of a site.

Creation of the site map using mapping module 262 includes adding devices 240 to the map and obtaining location or specification data for the added devices 240. For example, selecting a room identifier 322 on the interface of FIG. 3 may present an administrator with options to add a device to the room associated with the identifier 322. The user may identify the added device according to its type or capabilities or an ID that facilities control system 260 uses to lookup or otherwise obtain data regarding the added device 240. Facilities control system 260 may subsequently use device specification data for each device 240 to determine what operations the devices 240 can perform during execution of a growth plan.

Site maps such as shown in FIG. 3 can be used to document the arrangement of an existing site or to plan an arrangement of devices within the site. In particular, mapping module 262 can use available data on the shapes, sizes, or areas of the rooms in a site and the footprints of the plant-growing devices in the rooms in a planning algorithm to try to create an arrangement of the plant-growing devices that maximizes the usage of available space in a site or specific room. In particular, a planning algorithm may determine positions and orientations of devices in a room based on the shape or dimensions of the room, widths and depths of the footprints of the devices, and requirements for space between devices. Based on the planning abilities of the facilities control system 260, a user may decide which plant-growing devices to purchase or how to deploy available plant-growing devices. Even with algorithmic planning, the user can alter a site map to add, remove, modify, or rearrange the devices however the user would like.

Each device as shown in FIG. 3 may have a hierarchical designation identifying, for example, site, room, and device numbers corresponding to that device. (In FIG. 3, the names of the sites, rooms, and devices reflect the hierarchical designation, but more generally, names may be independent of the hierarchical designations, e.g., San Jose Site, Lab Room, or Room Humidity Sensor, to simplify use identification of the sites, rooms, or devices.) A growth plan module of the facilities control system may use the hierarchical designations to communicate with or issue commands to all devices in a subdivision of the hierarchy, e.g., to set all devices with the same site designation in an inactive (or active) mode when powering down (or up) a site, to switch grow lights settings of all devices in a room after completion of a planting operation in that room, or to direct a specific device to begin a diagnostic operation when an alarm or abnormality in that device is detected.

The site mapping module 262 may further use the hierarchical organization of devices 240 to zoom in and display information for devices 240 in a desired level or portion of the hierarchy. FIG. 4, for example, shows a display portion of a user interface presenting a user with an outline of a specific room (Room I.A) and display information on devices (Device I.A.1 to I.A.m). The room view of FIG. 4 may particularly provide more display area per device so that more device data or information can be displayed. In yet another view (not shown), the user interface may display information for a single device 240.

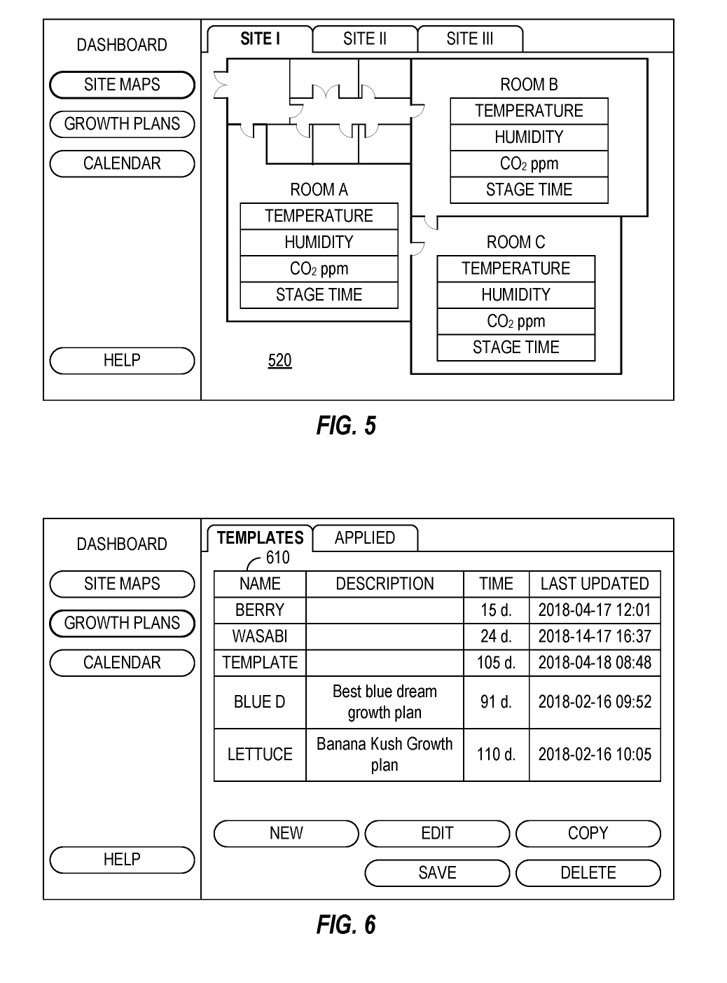

Facilities control system 260 described here may implement security levels to control what individual users can do using facilities control system 260. For example, a user may login for use of facilities control system 260 as an administrator, so that the user can use site mapping module 262 to add/remove/edit site, room, or device data or use growth plan module 264 to begin performance of a growth plan instance using a set of devices 240. In contrast, a user logged in for use of facilities control system 260 as a non-administrator may only be able to use site mapping module 262 to view current site and room arrangement and see the sensor readings or to use calendar module 266 to view any tasks to be performed. For example, facilities control system 260 may present a non-administrator with a site map such as shown in FIG. 5, where the site map 520 show a floor plan of a site with data on the stage time (or age) of plants in each room and the current temperature, humidity, and carbon dioxide concentration in each room based on the sensors deployed inside the rooms. The interface display of FIG. 5 may not allow a user to add or change data for devices 240.

Facilities control system 260 of FIG. 2 includes growth plan module 264 for creating, editing, and applying growth plan templates. In general, a growth plan template provides a time line for automated and manual operations to be performed as plants grow, e.g., when plants grow from a seed to a seedling or from a seed to a mature plant. A growth plan template may designate or represent operations to be performed during the growth of plants. Facilities control system 260 can apply a growth plan template to a group of devices 240 and may execute the growth plan using those devices 240 to perform automated operations and may communicate with a workforce, e.g., through calendar module 266, when the growth plan indicates a need for task to be performed. In general, whether an operation or task in a growth plan is automated or manual depends on the capabilities of the devices 240 being used.

Automatic operations as noted above include operations that device 240 can conduct as directed by facilities control system 260. For example, facilities control system 260 may direct one or more devices 240 to perform lighting operations, nutrient operations, atmospheric operations as required to maintain desired growing conditions designated in the growth plan. For a lighting operation using plant-growing device 100 of FIG. 1, for example, facilities control system 260 may direct or program local control unit 150 to monitor, maintain, or change the intensity or spectrum of the light that a grow light 130 emits. As a result, plants 114 receive the light designated in the growth plan. Atmospheric operations may operate atmospheric systems 140, e.g., air conditioners, heaters, humidifiers, misters, fans, or gas dispensers, to maintain target temperatures, humilities, carbon dioxide concentrations, and other atmospheric conditions designated in the growth plan. Nutrient operations may operate water supply system 122 and nutrient canisters and pumps in dosing and dispensing systems 124 and 125 to mix an provide to the plants nutrient solutions designated in the growth plan.

Manual operations are operations that require the action of a workforce to implement. For example, plant-growing device 100 of FIG. 1 may not be able to automatically perform operations such as some cleaning or maintenance operations or plant handling operations such as planting, repotting, or harvesting of plants 114. Facilities control system 260 may thus use calendar module 266 as described further below to schedule people to work on the devices 240 to which a growth plan is applied. Some operations such as detection of equipment problems, diagnosis of the problems, and the repair of problems may involve both automated and manual operations, which can be calendared and coordinated using facilities control system 260.

FIG. 6 shows a display of a user interface for manipulations of growth plan templates. In particular, FIG. 6 shows a listing 610 of available growth plan templates that may be stored for access by the facility control system. Growth plan templates may be a commercial product that are exchanged or traded among users or developers of the growth plan templates. Each glow plan template may correspond to a specific type and growth stage of plants and specific types of devices. The interface of FIG. 6 may enable a user to create a new growth plan template, copy an existing growth plan template, edit and save a growth plan template, or delete a growth plan template. Editing of a growth plan template may, for example, be used to improve a growth plan for better results in future instances where the growth plan is applied. Editing of a growth plan template may include a user entering control parameters or settings for automated or manual operations, e.g., for nutrient, temperature, light, CO₂, or water operations, based on the user's experience or through machine learning capabilities that may alter a growth plan template based on data collected when prior instances of the growth plan are applied to grow plants.

A growth plan template that is applied to the growing of plants is referred herein to a growth plan instance. A growth plan template would generally be applied to a set of plant-growing devices when the plants in the plant-growing are at a growth stage covered by the growth plan template. In some implementations, the facilities control system creates a growth plan instance based on a growth plan template and enables modification or editing of a growth plan instance while a growth plan is being executed. For example, parameters controlling watering, nutrients delivery, lighting, or atmospheric conditions may be modified based on the health and growth of plants served by the growth plan instance. Similar, parameters such as the timing and duration allotted for manual operations such as repotting or harvesting of plants may be altered based on the actual performance and availability of a workforce performing the manual operations. The control system may also offer options to promote a modified growth plan execution (Instance) to be a growth plan template to save a growth plan that provided good results or to record procedures found to be repeatable for successful plant growth. The control system may also allow a user to export or import growth plan templates for storage or knowledge sharing.

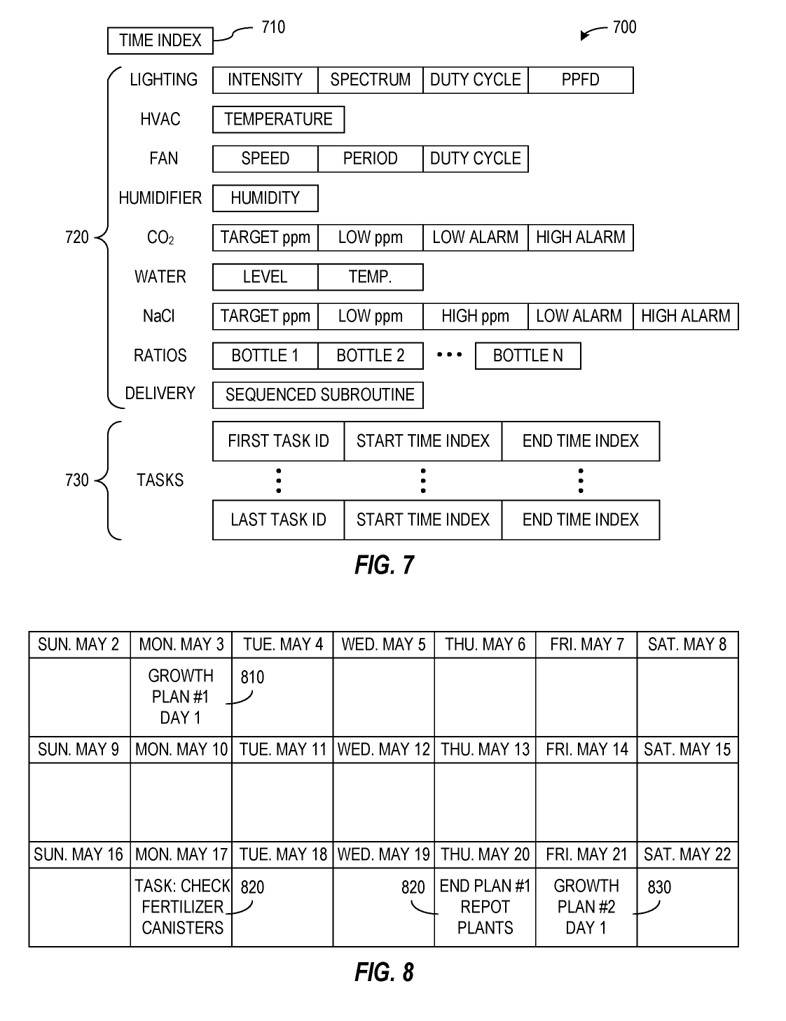

FIG. 7 shows an example of an entry 700 in a growth plan template. An exemplary growth plan template may include one or more entry having the format illustrated for data entry 700, and each entry may have a relative time index 710 indicating a relative time period during which the entry is applicable. Time index 710 may, for example, indicate a number of days since plants have reached an initial growth stage to which the growth plan applies. In general, entry 700 includes data structures or fields 720 that represent programming for devices during the time period associated with time index 710 and data structures or fields 730 that represent tasks to be perform during the time period associated with time index 710.

Device data structure 720 may be divided into fields indicating programming for specific devices or subsystems systems in plant-growing devices. In the illustrated embodiment, device data structure 720 represents programming for systems respectively for lighting, HVAC, ventilation fan, a humidifier, atmospheric CO₂ concentration monitoring and control, water systems, salt concentration monitoring and control, and nutrient mixing and delivery. The programming may take many forms depending on the specific device or system being programmed or controlled. For example, some devices may be programmed by setting of one or more operating parameters of the devices. Other devices may be programmed using a sequence or subroutine of instructions or machine codes that may be executed by the device, e.g., a local control unit, or by the computing system that implements the facilities control system. In the example of FIG. 7, entry 700 represents programming of lighting, HVAC, a ventilation fan, an atmospheric CO₂ concentration monitor, a water reservoir, a salt concentration monitor, and nutrient canisters through operating parameters for those systems, but nutrient mixing and delivery systems are controlled using a program sequence or subroutine.

Grow lights may have different target intensity, spectrum, duty cycle, and photosynthetically active photon flux density (PPFD) depending on the type of plant being grown and the growth stage of the plants being grown. FIG. 7 illustrates an example in which device data structure 720 includes parameters for intensity, spectrum, duty-cycle, and PPFD that the facility control system may program into grow lighting system(s) when the growth plan template including entry 700 is applied. Alternatively, if devices being used are not capable of monitoring and adjusting intensity, spectrum, duty-cycle, and PPFD, the facilities control system may monitor intensity, spectrum, duty-cycle, and PPFD during execution of the growth plan, and the facilities control system may change the controllable operating parameters of the devices to monitored lighting characteristic is out of the desired range. Entries for different time indices may alter these parameters according to the age of the plants or measured plant height or growth cycle.

An air temperature parameter in growth plan template entry 700 may represent a temperature that he facilities control system may set in an HVAC system for the room in which a batch of plants are being grown. A ventilation fan may also be operated constantly at a speed selected for the time index, the type of plant, or the growth stage of the plants, and entry 700 includes speed, period, and duty cycle parameters for programming of a fan system. A target humidity parameter in entry 700 can indicated the desired humidity for the plant type and growth stage of the plants being grown, and a humidifier, mister, or other system may be programmed to operate as need to maintain a desired humidity. A CO₂ concentration system may measure atmospheric carbon dioxide concentrations around the plants or in the room containing the plants and may release CO₂ to raise CO₂ concentrations. For a CO₂ system, entry 700 includes parameters representing a target concentration, a low concentration indicating a lower bound to an acceptable range of CO₂ concentration, and low and high alarm concentrations indicating problems. Alarm condition, which may be identified by a facilities control system or a plant-growing device detecting a CO₂ concentration above the high alarm level or below the low alarm level, may trigger facilities control system to take action, e.g., open a valve on a CO₂ canister or auto-generate a calendared task, to address the alarm condition.

Hydroponic plant-growing system generally require mixing water and nutrients to create a nutrient solution, and entry 700 of the growth plan template includes several parameters and subroutines for control of watering/nutrient systems. For example, hydroponic system may include a reservoir for water or nutrient solution, and entry 700 includes programming or parameters indicating a desired water or liquid level and temperature values for the reservoir. The facilities control system may program a device to maintain the desired water level and temperature indicated in the growth plan. The salt (NaCl) level in the nutrient solution for plants may similarly need to be monitored and controlled, and growth plan template entry 700 includes parameters indicating a target NaCl concentration, low and high acceptable NaCl concentrations, and low and high alarm NaCl concentrations. Alarm conditions such as too low or too high of a concentration of NaCl may trigger the facilities control system (or the local control unit) to initiate an automated or manual operation to diagnose and correct a problem cause the alarm. For example, a triggered operation may drain liquid from a reservoir and refill the reservoir with fresh water into which nutrients may be mixed.

Nutrient control may be one of the core parts of a growth plan system. In particular, the mixture and amount of nutrients provided to plants has many degrees of freedom that may be altered and optimized, and the particular choice of a mixture and amount of nutrients provided according to a growth plan may have significant effects on the growth or harvested yield of the batch of plants being grown. An automated hydroponic system may include multiple fertilizer canisters containing different types of nutrients that may be mixed into a nutrient solution and delivered to plants. Each of fertilizers may provide one or more of organic compounds, compounds of nitrogen, sulfur, or phosphorous, or other mineral compounds. The optimal mix of the fertilizers from the available canisters in a hydroponic plant-growing system generally depends on the plant type and the growth stage of the plant. Growth plan template entry 700 controls nutrients bottles using parameters indicating ratios for the nutrients provided from each canister. A delivery system can operate pumps to mix the nutrients from the canisters with water and to supply the resulting nutrient solution to the roots of the plants, e.g., as a mist applied to the roots in an aeroponic system. The operation of a nutrient solution mixing and delivery system may include multiple steps operating a collection of valves and pumps, and growth plan template entry 700 includes a subroutine that may be executed to mix and deliver nutrient solution in a plant-growing device.

Growth plan template entry 700 also includes task data structure or fields 730 representing automated or manual tasks that should be completed during the time period corresponding to time index 710 of entry 700. Task fields 730 may, for example, may include a task code or ID indicating the type of task to be performed, e.g., device cleaning, equipment diagnosis or repair, or planting, repotting, or harvesting of plants. A start time index is assigned to each task to indicate when the task should be performed, and a duration or end time index may also be assigned according to how long the task is expected to take. When a growth plan template is applied to a set of devices growing plants, the control system may use the task code and relative time indicators to create entries in a calendar, and the calendar may be provided to the workforce that may be executing some or all of the calendared tasks. For manual operations, the control system may further automatically select specific workers having time available to perform the task and may send the calendar entry to the assigned workers, or a manager may first see the calendar entry, and the manager may assign workers to complete the task.

The designation of operations as automatic or manual tasks generally depends on the capabilities of the devices. In particular, a plant-growing device may have self cleaning abilities that may or may not be sufficient at all times. For example, a watering system having an auto cleaning functionality may be calendared to perform a cleaning operation at a specific time, e.g., as a flush or backwash operation where normal flows are reversed or redirected. Such automated operation may be executed without any workforce involvement or a worker may be assigned to assist, complete, or document an otherwise participate in an automated operation.

FIG. 8 shows a user interface display that a facilities control system may provide for calendaring functions. The calendaring functions may include creating tasks to be performed at times and days specified in the calendar, assigning resources and workers to complete the calendared task, communicating information among people sharing the calendar, and recording events and data relating to one or more instances of growth plan being implemented on devices in the plant-growing facilities. The calendar of FIG. 8 indicates that an instance of “Growth Plan #1” was applied to a set of devices on a specified date 810. When the growth plan template corresponding to Growth Plan #1 was applied, the facilities control system, based on the relative time indices in the growth plan template, created auto-generated tasks 820 to be performed automatically, semi-automatically, by the workforce on the specified days/times indicated in the calendar. For example, workers may need to check and refill fertilizer canisters on one date and may need to repot or harvest plants at the last day of Growth Plan #1. As noted above, the facilities control system may initially auto-assign manual tasks to workers from the available workforce subject to reassignment by an administrator or an administrator may make the initial assignments and any reassignments the workers to perform manual tasks. A new “Growth Plan #2” may be applied at any time to begin on a day 830, e.g., immediately after the repotting of the plants signifying that the batch of plants have attained their next growth stage.

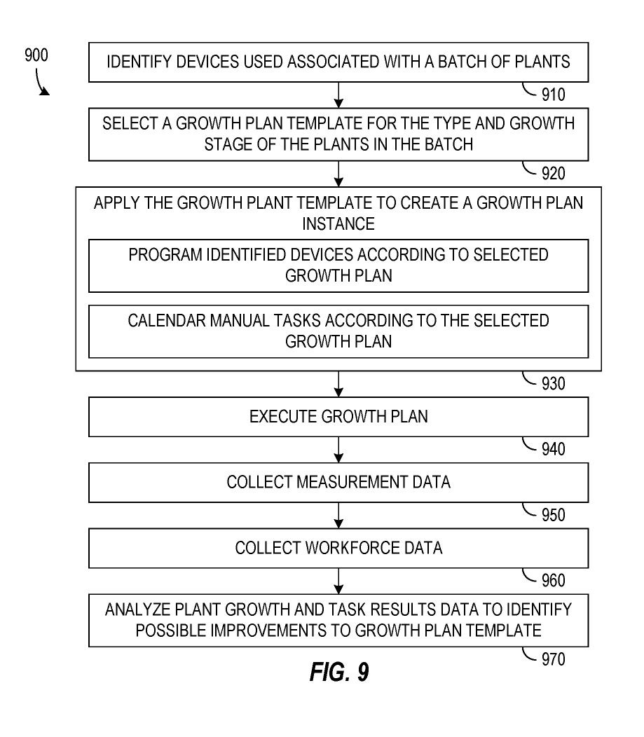

FIG. 9 is a flow diagram of a process 900 for using and improving a growth plan. Growth plans as described above provide a plan for using a set of devices for growing of a batch of plants. Step 910 of process 900 involves identifying the set of devices that are going to be used to grow a batch of plants corresponding to the growth plan. The device may include multi-function plant-growing devices such as plant-growing device 100 of FIG. 1 or separate component devices such as sensors, lights, heating and air conditioning provided in the room or site containing the plant-growing devices. In one implementation, the devices used to grow a batch of plants may be all devices associated with a room or other subdivision in a hierarchical mapping such as described above.

In a step 920, a user of the control system selects a growth plan template to be used for the batch of plants. As noted above, a facilities control system may access a stored list or library including multiple growth plan templates, and the growth plan templates may respectively correspond to specific plant types and specific plant growth stages. If the facility control system does not already include a growth plan template that a user wants for the plant type and growth stage of the batch of plants, a user may use the facilities control system to create or author a new growth plan template, for example, by selecting or entering the programming parameters, the subroutines, and the workforce tasks or by editing and saving an existing growth plan template.

A user may use the control system in a step 930 to apply the selected growth plan template to the identified devices and thereby create a growth plan instance. Applying the selected growth plan may include programming the identified devices with parameters or subroutines represented in the selected growth plan template. Applying the selected growth plan may further include auto-generating one or more tasks in a calendar as illustrated in FIG. 8 based on relative time indicators for tasks in the growth plan template. The control system may also automatically assign the tasks corresponding to manual operations to available workers, may prompt a user to assign such tasks to workers, or may leave tasks unassigned.

A growth plan may include programming for the facilities control system or local control units to execute as the batch of plants grow, and the facilities control system may perform further monitoring operations, device programming, and task calendaring while executing the growth plan instance in a step 940. In particular, the facilities control system may monitor the devices for alarms or error conditions, and the facilities control system may reprogram the devices to perform diagnostic or other automated operation or may auto-generate calendar entries for tasks when an alarm or error condition arises. Additionally, a growth plan as described above may include entries for multiple time indices, and the control system may reprogram the devices or generate new tasks when other entry times arrive.

The facilities control system may further collected measurement data and workforce data in steps 950 and 960. Data collection may be performed though out the time period of the growth plan instance. In particular, in step 950, measurement data may be periodically collected from sensors that measure environmental conditions such air or water temperatures, atmospheric CO₂ concentrations, light intensity, and fertilizer usage in the devices and or that measure plant characteristics such as height, volume, or growth stage. Workforce data, which workers may enter when completing tasks, may be collected in step 960 and may include start times and end times for the workforce tasks and worker's indications of the results of completion of the tasks. The facilities control system or a user of the facilities control system in a step 970 may use measurement data and the workforce data collected in steps 950 and 960 (and data collected for other instances of the same growth plan template) to determine the success of the growth plan and identify possible improvements in the growth plan template. A growth plan template may thus be refined based on actual instances in the plant-growing facilities to provide a growth plan that realistically optimizes workforce utilization and plant growth results.

The above describes some specific examples in which plant-growing facilities grow plants hydroponically, but more generally, the disclosed techniques and systems could be employed for facilities with devices for growing plants in soil, e.g., in greenhouses.

Each of the devices and modules disclosed herein may include, for example, hardware devices including electronic circuitry for implementing the functionality described herein. In addition or as an alternative, each device or module may be partly or fully implemented by processing hardware executing instructions encoded on a machine-readable storage medium.

All or portions of some of the above-described systems and methods can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. A control system for plant-growing facilities, comprising:
a template stored in a computing system and representing programming for devices in the plant-growing facilities and one or more tasks to be performed during a growth plan; and
an execution module executed in the computing system and controlling the devices while the devices are used to execute the growth plan to grow a batch of plants, the execution module being configured to program the devices based on the programming represented in the template and to generate one or more calendar entries based on the one or more tasks represented in the template, each of the calendar entries identifying a time for a workforce to perform one of the tasks represented in the template.

2. The control system of claim 1, wherein the template is selected from among a plurality of growth plan templates as being a growth plan template that corresponds to a plant type of the batch of plants being grown using the devices.

3. The control system of claim 2, wherein among the plurality of growth plan templates, the template is a growth plan template that corresponds to a growth stage of the batch of plants being grown using the devices.

4. The control system of claim 1, wherein programming the devices comprises controlling one or more of lighting, nutrients, and atmospheric conditions that the devices provide to plants being grown using the devices during the instance of the growth plan.

5. The control system of claim 1, further comprising a calendar module configured to maintain a calendar including an entries respectively indicating types for the tasks and the times for the workforce to perform the tasks, wherein the calendar module is configured to permit an administrator to alter the entries and to convey information from the calendar to the workforce to perform the tasks.

5. The control system of claim 1, further comprising a growth plant module configured to enable modification of the template.

6. The control system of claim 1, further comprising a data analysis module configured to modify the template based on data collected on the batch of plants grown using the devices.

7. The control system of claim 6, wherein the data includes measurements collected during execution of the growth plan to grow the batch of plants.

8. The control system of claim 7, wherein the data further includes measurements collected during prior executions of the growth plan to grow prior batches of plants.

9. The control system of claim 6, wherein the data includes information input by the workforce that performed one of the tasks represented in the template.

10. A method comprising:
introducing a batch of plants into a plurality of plant-growing devices;
selecting a template representing a growth plan; and
operating a control system executed in a computing system to perform operations including:
programming the devices based on a programming represented in the template; and
generating one or more calendar entries based on one or more tasks represented in the grow plan template, at least one of the calendar entries identifying a time for a workforce to perform one of the manual tasks represented in the template.

11. The method of claim 10, wherein selecting the template comprises identifying from among a plurality of growth plan templates that the selected growth plan template corresponds to a plant type of the batch of plants.

12. The method of claim 10, wherein selecting the template further comprises identifying among the plurality of growth plan templates that the selected growth plan template corresponds to a growth stage of the batch of plants.

13. The method of claim 10, further comprising executing the growth plan for the batch of plants, wherein executing the growth plan includes:
the devices operating as programmed; and
the workforce completing the manual tasks.

14. The method of claim 13, further comprising modifying the template based on data collected during the executing of the growth plan.
